(19) United States
(12) Patent Application Publication
(10) Pub. No.: US 2020/0146262 A1
(43) Pub. Date: May 14, 2020

(54) ANIMAL DEVICE

(71) Applicant: Förster Technik GmbH, Engen (DE)

(72) Inventor: Thomas Förster, Bodman-Ludwigshafen (DE)

(21) Appl. No.: 16/680,569

(22) Filed: Nov. 12, 2019

(30) Foreign Application Priority Data
Nov. 12, 2018 (DE) 10 2018 128 204.4

(51) Int. Cl. A01K 27/00

(52) U.S. Cl. CPC A01K 27/001; A01K 27/006

(57) ABSTRACT

The invention refers to an animal device with an electronics, whereby the electronics (1) has a belt holder (2) and a belt (3), whereby the belt holder (2) includes a first part (4) and a second part (5), the first part (4) having a belt insertion hollow (6), in which the belt (3) is receivable, the second part (5) being complementary to the first part (4) and closing the belt insertion hollow (6) in the working position.

### BACKGROUND OF THE INVENTION

The invention refers to an animal device having electronics, a belt holder and a belt.

Such animal devices are already known and used in a variety of forms and designs. For example the DE 10 2016 107 624 A1 discloses an animal device. The special feature here is the fact that an adjustable display device can be attached to an animal neck with a belt and that corresponding information about the animal is reproduced in the display device.

### SUMMARY OF THE INVENTION

The purpose of this invention is to provide an animal device that can be easily connected and disconnected to a belt so that the belt can be better cleaned without affecting the electronics in the animal device.

The characteristics disclosed herein lead to the solution of the object.

Advantageous embodiments are described herein and in the dependent claims.

The animal device according to the invention has electronics. This can be a display device and/or GPS location or the like, which can have a self-sufficient energy source in the form of a rechargeable battery. The purpose of the animal device is not only to “display” information, but it may also be that the electronics is a pure sensor for animal data (e.g. activity). It can also be a pedometer, microphone, thermometer, localization or the like.

The animal device can also be suitable for sending or receiving “information” via a communication channel to a higher-level unit via infra-red data transmission or the like, whereby alignment to a transmitter/receiver would then be necessary.

The electronics has a belt holder in which a belt can be attached. The belt can be attached to an animal neck, belly, tail, leg or the like.

The belt holder consists of a first part and a second part, whereby the first part has a belt insertion recess in which the belt can be inserted. The second part is complementary to the first part and closes the belt insertion recess in the working position. Closing means here that the belt received or inserted can be connected to the belt holder. Closing can be done manually or with a tool or a key at any time. This increases the wearing comfort for the animal, since the strap does not have to be handled unnecessarily long to open it, for example if the electronics have to be serviced, charged or replaced. This can be done in a simple way, since the strap could remain on the animal, for example.

The working position is when the first part is connected to the second part and the belt is connected to the belt holder. The resting position is when the first part is released from the second part and the belt can be removed for cleaning purposes, for example. This protects the electronics and the belt can simply be thrown into a washing machine, for example.

The first part consists of a first belt guide, a second belt guide and an interruption between the two belt guides.

Furthermore the second part is T-shaped. It consists of a pressure piece and a locking web arranged at right angles in the middle of the pressure piece and protruding from it. A clip closure is arranged on the locking web at the other end of the pressure piece. The clip closure consists of two resilient pins with locking parts arranged at the ends.

The belt holder has a clip guide in the area of the interruption. The clip guide consists of two parallel guide webs. To come from the resting position to the working position, the locking web is between the two guide webs and pushed in until both locking parts slide out of the two guide webs and after passing through a clip opening due to the spring-loaded pins expand and prevent a slipping back.

The two guide webs are at one end in working position in contact with the pressure piece and at the other end with the clip opening, whereby in working position the clip closure is inserted into the clip opening.

The two belt guides each have a pin receptacle which can be connected to the guide pins of the pressure piece in the working position. The pin holder and guide pins simplify the adjustment of both parts to each other.

In a preferred embodiment, the belt runs in such a way that it is arranged between the two guide webs and the two belt guides.

The key has a circular recess and a U-shaped recess. The U-shaped recess is fitted onto the locking parts which have expanded in the working position in order to press the two locking parts towards each other. This allows the two locking parts to slide back through the clip opening and thus the first part is detached from the second part.

The locking parts can be designed in such a way that they can be compressed by hand. That means they are manually accessible. This in turn means that the locking parts in working position are large enough and also protrude out of the clip opening so far that one can squeeze them with the fingers.

In another embodiment, the locking parts are located on the clip opening so that they cannot be opened manually. This can be, for example, due to a protected location or the fact that the locking parts are simply too small. Here would be the advantage that the locking parts do not accidentally get compressed by a bush or by the animal itself, because they do not provide a corresponding attacking area. Then the described key is necessary to allow an opening and to leave the working position.

To clean the belt, the electronics can be easily removed from the belt and the belt can be placed in a washing machine, for example. Afterwards the electronics can be easily inserted on the belt without threading or threading away the other “components”, such as numbers or the like. The attaching and removing of the electronics is also possible when the belt remains on the animal. This is also important at an eventual addition, or if the electronics are only of use for certain periods of time (e.g. rutting recognition) and is then used for another animal. This can also be useful for charging a battery, for example. Furthermore it is advantageous that the wearing comfort for the animal is increased in comparison to the state of the art. For example, the animal device has a lower design height as is the case in the state of the art, e.g. when a fastening with screw constructions is achieved, which regularly leads to pressure points at the animals. Pressure points are prevented in the animal device according to the invention.

Another advantage of the inventive animal device is that the electronics are attached without any threading, both when the belt is attached to the animal and when the belt has been removed (e.g. for cleaning purposes) and is lying loosely around.

The main advantage is that no threading is required. Since the belt is usually carrying other parts, such as an RFID tag, or a number, etc., and the inventive animal device shall often be inserted between existing parts these do not have to be removed separately in order to insert then the inventive animal device and then again the previously removed part. This advantage is particularly evident, when, for example, an inventive animal device should be upgraded with expensive electronics.

On the one hand, a farmer who has already equipped his animals with belts, could add the subsequently purchased part without threading in a simple way. On the other hand, a farmer can always attach particularly expensive and only rarely used parts to the belts of the animals that currently need them. So, a cow carries 9 months in the year and is then three months receptive to become pregnant again. The expensive sensor technology to the rutting detection of course is only necessary in the three months mentioned. Here it is especially advantageous if the expensive sensor technology can be taken out again after a cow is pregnant to be assigned to another cow then.

### BRIEF DESCRIPTION OF THE DRAWINGS

Further advantages, features and details of the invention result from the following description of preferred execution examples as well as on the basis of the drawings; these show in:

FIG. 1 shows an animal device in working position without an inserted belt;

FIG. 2 shows the animal device from FIG. 1 in resting position;

FIG. 3 shows the animal device from FIGS. 1 and 2 in working position with inserted belt;

FIG. 4 shows the animal device in working position;

FIG. 5 shows the animal device in resting position.

### DETAILED DESCRIPTION

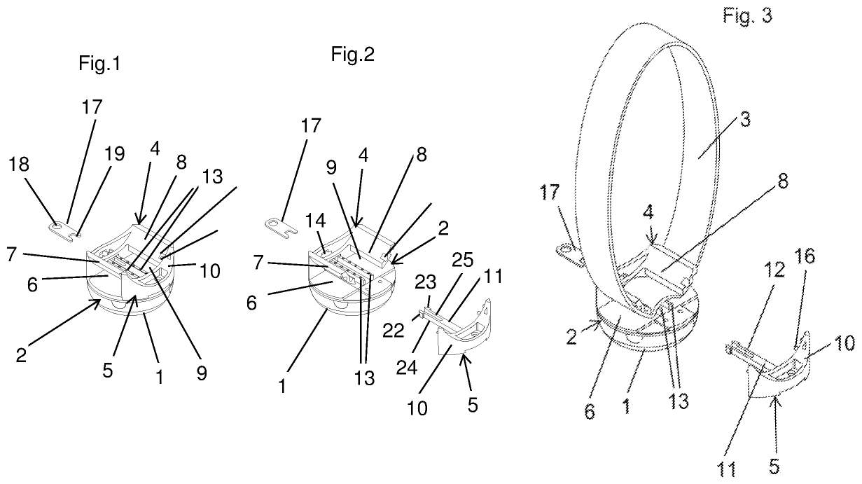

FIG. 1 shows an animal device in working position with electronics 1. Thereby the electronics 1 is connected with a belt holder 2. The belt holder 2 consists of a first part 4 and a second part 5.

The first part has a belt insertion hollow 6, in which a belt 3, as it is shown in FIG. 3, is receivable. The second part 5 is complementary to the first part 4 and fixes the belt 3 in the belt insertion hollow 6 in working position. Thereby the belt insertion hollow 6 is closed.

The first part 4 further consists of a first belt guide 7 and a second belt guide 8, whereby between the two belt guides 7, 8 there is an interruption 9.

Further a key 17 is shown, which has a circular recess 18 and a U shaped recess 19. The circular recess serves the better handling or e.g. for attachment to a key ring. The U shaped recess is used to unlock the second part 5 from the first part 4.

FIG. 2 shows the animal device in resting position. Thereby the second part 5 is T-shaped. The second part 5 consists of a pressure piece 10 and a locking web 11 arranged at right angles in the middle of the pressure piece 10, wherein at the locking web 11 a clip closure 12 is arranged at the other end of the pressure piece 10. The clip closure 12 consists of two resilient webs 24, 25 each having a lock 22, 23.

The belt holder 2 has a clip guide in the area of the interruption 9, consisting of two parallel arranged guide webs 13. The two guide webs 13 are at one end in working position in contact with the pressure piece 10 and at the other end a clip opening 14 is provided, wherein in working position the clip closure 12 is inserted into the clip opening 14.

The two belt guides 7, 8 each have a pin receptacle 15, which can be connected to guide pins 16 of the pressure piece 10 in working position.

In FIG. 3 the belt 3 is arranged in such a way that it can be placed between the guide webs 13 and the two belt guides 7, 8. The threading is possible in a simple way through the removable second part 5. In the working position, the threaded belt 3 is firmly attached and cannot be unintentionally released.

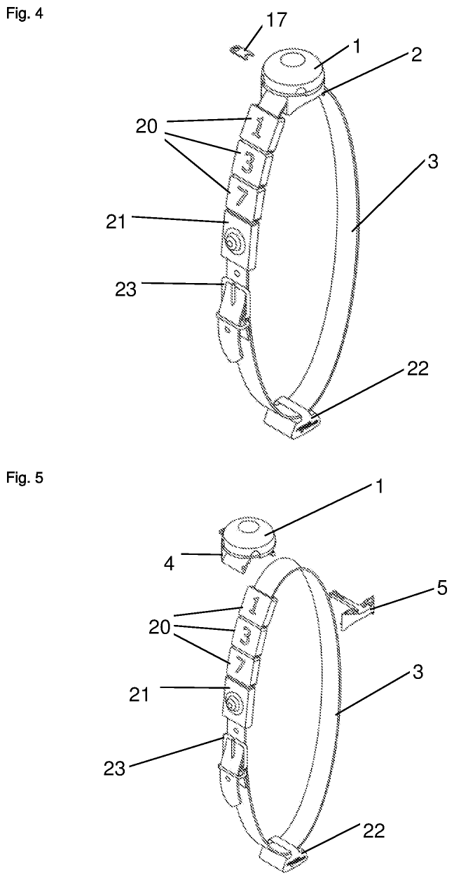

FIG. 4 shows the animal device from a different perspective. In addition to the features already described above, FIG. 4 also includes new features. Thus, a counterweight 22 can be found threaded to the belt 3, which is necessary for some applications. This counterweight 22 is threaded here, which corresponds to the state of the art.

Furthermore, there is an RFID tag 21 attached to the belt 3. Also, the key 17 is shown. At last there are three number plates 20, which can be used, for example, to identify an animal or certain characteristics of the animal. In another embodiment the RFID tag 21 can be also be integrated in electronics 1. The explanations from FIGS. 1 to 3 also apply to FIGS. 4 and 5. In particular, if the same reference numbers are used.

FIG. 5 shows the animal device in resting position. Thereby the electronics 1 is separated from the belt 3, with the first part 4 and the second part 5 being separated accordingly here. This can be done in an advantageous way without the animal device being unthreaded on the counterweight 22 or the number plates 20, or past RFID tag 21. This is an advantageous work facilitation for the user.

### REFERENCE LIST

1 Electronics
2 Belt holder
3 Belt
4 First part
5 Second part
6 Belt insertion hollow
7 First belt guide
8 Second belt guide
9 Interruption
10 Pressure piece
11 Locking web
12 Clip closure
13 Guide web
14 Clip opening
15 Pin receptacle
16 Guide pin
17 Key
18 Circular recess
19 U-shaped recess
20 Number plate
21 RFID tag
22 Counterweight
23 Belt buckle

1. An animal device with an electronics (1), the electronics (1) having a belt holder (2) and a belt (3), wherein the belt holder (2) comprises a first part (4) and a second part (5), the first part (4) having a belt insertion hollow (6), in which the belt (3) is receivable, the second part (5) being complementary to the first part (4) and closes the belt insertion hollow (6) in the working position.

2. The animal device according to claim 1, wherein the first part (4) comprises a first belt guide (7), a second belt guide (8), and an interruption (9) located between the first belt guide (7) and the second belt guide (8).

3. The animal device according to claim 1, wherein the second part (5) is T-shaped and comprises a pressure piece (10) and a locking web (11) arranged at right angles in a middle of the pressure piece (10), wherein at the locking web (11) at the other end of the pressure piece (10) a clip closure (12) is arranged.

4. The animal device according to claim 2, wherein the belt holder (2) has a clip guide in the region of the interruption (9), consisting of two guide webs (13) arranged in parallel.

5. The animal device according to claim 4, wherein the two guide webs (13) are in working position at one end in contact with the pressure piece (10) and at the other end have a clip opening (14), wherein, in working position the clip closure (12) is inserted into the clip opening (14).

6. The animal device according to claim 3, wherein the two belt guides (7, 8) each comprise a pin receptacle (15), which are connectable with guide pins (16) of the pressure piece (10) in working position.

7. The animal device according to claim 1, wherein a key (17) is provided which releases the clip closure (12) in the working position and brings it into the resting position.

8. The animal device according to claim 7, wherein the key (17) has a circular recess (18) and a U-shaped recess (19).
